(19) United States
(12) Patent Application Publication
(10) Pub. No.: US 2017/0199010 A1
(43) Pub. Date: Jul. 13, 2017

(54) System and Method for Tracking and Locating Targets for Shooting Applications

(71) Applicants: Jonathan Patrick Baker, Chanhassen, MN (US); Priyadarshee Deeptarag Mathur, Chanhassen, MN (US)

(72) Inventors: Jonathan Patrick Baker, Chanhassen, MN (US); Priyadarshee Deeptarag Mathur, Chanhassen, MN (US)

(21) Appl. No.: 15/402,818

(22) Filed: Jan. 10, 2017

Related U.S. Application Data
(60) Provisional application No. 62/277,150, filed on Jan. 11, 2016.

(51) Int. Cl. F41G 3/26; G06T 7/70; G06T 7/20; G09B 5/02; H04N 5/91; G11B 27/34; H04N 5/765; G06K 9/00; H04N 5/225

(52) U.S. Cl. CPC F41G 3/2605; G06K 9/00724; G06K 9/00671; G06T 7/70; G06T 7/20; H04N 5/2252; H04N 5/91; G11B 27/34; H04N 5/765; G09B 5/02; G06K 2009/00738; G06T 2207/20081; G06T 2207/20224; G06T 2207/30221; G06T 2207/30241; G06T 2207/30244

(57) ABSTRACT

A system and method for recording, detecting and tracking objects on a digital record to provide an effective and efficient means to improve performance during training experiences. Merely by way of example, a preferred embodiment of the invention utilizes a video recording device to record clay pigeon shooting experiences for the purpose of improving shooter performance by analysis of the video record. The invention provides a system attached a recording device to a weapon and a method to analyze the record that will identify the relevant events, determine object(s) location, determine if the event has a favorable outcome or not (e.g. hit/miss), and display the object(s) path prior to, during and after an event occurs (e.g. a shot). The method will also determine the weapon's aimpoint path relative to the object(s) location to provide an efficient and effective training aid. This ability to show the user (or other observers) this aimpoint path simultaneously synced in time with the path of the target(s) provides synchronized feedback that proves to be very effective to improve shooter performance.

### CROSS-REFERENCE TO RELATED APPLICATIONS

This application claims priority from U.S. Provisional Patent Application No. 62/277,150, filed Jan. 11, 2016, which is incorporated herein by reference in its entirety.

### BACKGROUND OF THE INVENTION

Field of Invention

The present invention relates to target training and education systems and more particularly to devices, systems and methods for providing feedback on aiming accuracy during shooting activities. Furthermore, this invention relates to improvements in the effectiveness of systems that are used to show feedback of a user's performance with a weapon (e.g. firearm, bow/arrow device, crossbow, or other device used to shoot projectile(s) at targets) while engaging in these shooting activities.

Related Art

Within this field of invention, there are many approaches to achieve improvements in the user's shooting performance. Many of these approaches use simulated environments, or in other applications special devices used to simulate the weapon itself. These simulating devices, environments and training aids that employ such simulations introduce limitations to the training experience, as they do not fully replicate the shooting experience. U.S. Pat. No. 8,496,480, to Guissin, discloses a video camera integrated with a weapon to provide video recording in operational training. The simulation aspects of this approach limit effects realized from actual shooting conditions (e.g. environment, physical recoil).

Still in other approaches, the inventions do not re-create or develop the training experience in an efficient manner to enable a fully beneficial experience. It is generally accepted that for maximum benefit from a training experience, the user needs to experience and re-experience the training repetitively to understand, remember, and absorb the lessons from the training. Given this point, the level of efficiency from the training experience can significantly add to user's benefit from the training. A commercially available system, Laserport, sold by the English company Powercom (UK) Ltd, utilizes a laser reflected off a simulated target to indicate hits or misses. This approach provides an indication of hits and misses, but does not enable replays of the user's past performance for training purposes. Furthermore, this system does not provide a realistic simulation experience of the user's swing profile, which would enhance the training experience. The efficient delivery of the playback from the training experience is an important aspect of the training aid used. This aspect has been found lacking in prior inventions and approaches previously employed.

Still, other approaches employ specialized apparatus attached to the weapon to enable the training experience. This approach can be a preferred means to effectively teach the user, as it can more closely replicate the user's actual shooting experience. There are drawbacks to these approaches whereas the added apparatus increasingly alters the user experience. As the added apparatus becomes more intrusive, it is more difficult for the user to have an unaffected shooting experience. U.S. Pat. No. 5,991,043, to Andersson and Ahlen, discloses a video camera with gyroscope mounted on a weapon to determine impact position on a moving target; the means employed to calculate position, distance and image size introduce error that isn't present when utilizing other methods. Furthermore, Andersson's approach yields only the impact point after calculations and estimates are made as to the future position of the clay and aim of weapon.

As inventions' approaches become less invasive to the user's natural shooting routine, the invention will be able to deliver a more effective training experience. Therefore, new means to deliver a more effective training experience can be found through incorporation of less intrusive means to a typical shooting experience.

Furthermore, other devices are employed to achieve improve shooting performance during the shooting experience, i.e. in “real-time.” U.S. Pat. No. 7,836,828, to Martikainen, is an example an embodiment of these devices employed in shotgun shooting sports, which is a high visibility wads are used in some shotgun loads to provide improved visible tracking of the shot stream immediately after the weapon is fired. These approaches have limitations in several ways, none of the least of which, that they only provide feedback at the time of discharge of the weapon. Furthermore, these approaches do not provide any user feedback on swing characteristics of the weapon prior to discharge.

Additionally, an observer can also provide training instruction for the user. This instruction is usually in the form of advice to user as to how they can improve their aim, shooting form, or delivery of the shot itself during the training experience. There are numerous shortcomings of these real-time approaches that are readily apparent to someone trained in this field. But for the purposes of this background, these shortcomings will be limited to a brief discussion. These devices and other observers introduce error through interpretation, assumptions and estimation that is further complicated by the very short timeframe that the information is available during and after the time the shot occurs. Furthermore, the experience in this situation can only be experienced once and then must be remembered after it occurs. This creates difficulty to recall multiple training instances.

Such systems as briefly outlined above, however, fail to provide a complete, effective training system with adequate precision of target tracking, efficient delivery of review methods, and minimal artificial additions to user's shooting experience—inclusive of apparatus, processes, or constraints.

### SUMMARY OF THE INVENTION

The present invention is a system and method for target training and education that will improve shooting performance in shooting situations, such as, but not limited to, clay pigeon shooting, archery target shooting, or rifle target shooting. It is therefore an object of the invention to provide a system to, either removably or permanently, attach a recording device to a weapon for the purposes of providing means to record the environment during a shooting event.

This invention will also provide a method for processing the recorded shooting event that is not attached to the weapon, but which will enable usage of the following objectives of this invention.

Another object of the invention is a method to analyze the record of the shooting event that enables efficient playback and effective training after the shooting event. It is a further object of the invention that this method employs automated analysis techniques that remove unnecessary and non-relevant video from the training playback record. A part of this automated analysis process detects the occurrence of shot(s) in the recorded video and uses these shot event(s) to trigger actions on the video. Specifically, a useful action of such shot detection is to identify specific portion(s) of the recorded video, so that it, and similar events, can be aggregated to create a condensed set of video(s) of the selected events relevant to the training feedback.

A still further object of this invention is that the audio portion of the video record can be used in a novel way to detect the presence of the shot(s) by using digital processing techniques to determine the presence of a shot in a video record. A further object of this invention is that the analysis method applies video processing techniques that use characteristics of pixels in the frame(s) of the video, such as, but not limited to, color channel, hue, focus, clarity, jitter, or rate of change of these characteristic, to further improve the detection of a shot in the video record.

Another object of this invention is to describe an effective training system and method with and without the recording mechanism attached to the weapon that enables the user or observer with the ability to view the training event as many times as desired. This ability to repeatedly review the training event with the invention's annotated video and analysis methods enables a superior training experience.

This invention has a further objective to provide techniques that locate the aimpoint of the weapon on the training record. One use of this recorded aimpoint is to provide the relative location between the aimpoint of the weapon and the target(s) locations during training feedback from the shooting events. The aimpoint is determined by referencing specific region(s) of the video frame. Since the recording device is held firmly in place on the weapon, this frame region is a repeatable reference location during the video playback. More specifically, a particular point within that region can be determined to be coincident with the user's aimpoint. As a point of illustration, this specific point will remain ‘X’ pixels on the horizontal video frame axis and ‘Y’ pixels on the vertical video frame axis. Thereby, the frame's location (denoted by X, Y coordinates recorded for each frame) will be the aimpoint path of the user's weapon throughout the duration of the video. By recording this aimpoint location for each frame during video playback, the user's aiming path is recorded and is coherently maintained as part of the video record. This user aimpoint path provides added degrees of value during the training playback, since an observer can see how the weapon was moved throughout the shooting event(s).

Yet another object of the invention is to provide further analysis of the record that detects and tracks targeted object(s) during the shooting event. Specifically, the analysis method tracks the object(s) before, during and after the weapon's shot. In the same manner as the method records the X,Y location for the aimpoint, this method records the frame location coincident with the location of the targeted object(s) for each frame in the relevant portion(s) of the video. As with the aimpoint path described earlier in this document, the X,Y location pairs for the target is recorded and is coherently maintained as part of the video record. This target path(s) provides added degrees of value during the training playback, since an observer can see each of the target's flight path(s) during the shooting event.

This method's ability to show the user (or other observers) this target(s) path simultaneously synced in time with the path of the aimpoint(s) provides time-based feedback of the training record. This record is not available with other training aids and methods, which do not provide such synchronized feedback of both the aimpoint and the target(s) throughout the shooting event.

Still another objective of this invention is to provide techniques to analyze the training experience that will permit the user to understand the reasons for hitting or not hitting the targeted object(s) (i.e. a ‘hit’ or ‘miss,’ respectively). These analysis techniques will use information provided on the specific weapon (e.g. shotgun, rifle, bow-arrow, slingshot, spear, or other object used as a weapon) in use, the targets (e.g. a clay pigeon, ball, silhouette, paper target, animal, or other object), environmental conditions, and data derived from the invention's analysis (e.g. target and/or weapon aimpoint motion, travel path(s), trajectories, relative locations) to interpret if the target should be considered a hit or miss after a given event occurs (e.g. a shot).

As an illustrative example, the time when the projectile(s) from the weapon reaches the target can be determined through the invention's analysis and is noted as part of the video training record (e.g. video). This time is when the projectile(s) can come into contact with the target (e.g. point of impact). This point of impact is referenced to a specific frame in the video, as part of the invention's analysis. In this ‘point of impact’ frame, the aimpoint X,Y coordinates and the target X,Y coordinates are evaluated. If the coordinates are in sufficiently close proximity to each other, this condition is considered a ‘hit.’ The corresponding video playback enables confirmation of the ‘hit’ based on the results seen in the video (e.g. once the shotgun pellets contact with the clay pigeon target, this target would become broken and fly in pieces, which is visible on the video). Although the specific illustration in this description reference clay pigeons shot by a shotgun, other weapons and targets used with this invention will benefit from the same training record approach.

The invention will be more clearly understood and additional advantages will become apparent after a review of the accompanying description of figures, drawings and more detailed description of the preferred embodiment.

### BRIEF DESCRIPTION OF THE DRAWINGS

FIG. 1 is a perspective view of a recording system removably attached to barrel of a weapon;

FIG. 2 is a perspective view of the recording system of FIG. 1 with camera installed as recording device;

FIG. 3 is an exploded diagram view of the recording system of FIG. 2 showing a fixture, a recording device, a storage medium and wireless communication options of the present invention;

FIG. 4 is an alternate shape of the fixture of FIG. 3;

FIG. 5 is a perspective view of the recording system of FIG. 1 shown in an alternate mounting location behind the magazine cap of the weapon;

FIG. 6 is a perspective view of the fixture of FIG. 1 shown in another alternate mounting location on the side of the weapon;

FIG. 7 is an illustration of a placard used as part of an optional calibration routine;

FIG. 8 is an illustration of an embodiment of the invention showing video files being transferred to a processing computer;

FIG. 9 is an illustration of an embodiment of the invention showing a transformed, digital representation of a calibration placard;

FIG. 10 is an illustration of another embodiment of the invention showing a transformed digital representation of a calibration placard;

FIG. 11 is a flowchart of an embodiment of the invention's analysis process that outlines the analysis steps;

FIG. 12 is an illustration of digital filter method used to extract energy, by frequency ranges, from the audio channel;

FIG. 13 is a graphical illustration of band pass filter outputs of the audio channel;

FIG. 14 is a graphical illustration of band pass filter energy levels by video frame;

FIG. 15 is a graphical illustration of the process method to qualify motion between object(s) on multiple frames in the video file;

FIG. 16 is a graphical illustration of the process method to qualify focus between object(s) on multiple frames in the video file;

FIG. 17 is an illustration of an embodiment of the invention showing the process to extract motion from successive frames of the recorded training record;

FIG. 18 is an illustration of an embodiment of the invention showing the process to extract the aimpoint and target(s) locations from the recorded training record;

FIG. 19 is an illustration of an embodiment of the invention showing the process to determine motion in the aimpoint and target(s) between frames of the recorded training record;

FIG. 20 is an illustration of object detection technique used in the analysis process;

FIG. 21 is an illustration of an embodiment of the invention showing an object detection technique employed by the analysis process;

FIG. 22 is another illustration of an embodiment of the invention showing an object detection technique employed by the analysis process;

FIG. 23 is an illustration of an embodiment of the invention showing the output from the target trajectory selection process in the analysis process;

FIG. 24 is an illustration of an embodiment of the invention showing the comparison between two object detection methods;

FIG. 25 is an image of an embodiment of the invention that shows a still image from the training record with the target tracking and aimpoint tracking annotated on the image;

FIG. 26 is a graphical illustration of multiple pairs of the target and aimpoint tracking representing an embodiment of the invention showing a trap shooting training experience; and

FIG. 27 is a graphical illustration of multiple swing velocity graphs of both target and aimpoint locations derived from the analysis.

### DETAILED DESCRIPTION OF A PREFERRED EMBODIMENT

In order to more fully illustrate the present invention, the following will describe a particular embodiment of the present invention with reference to the figures. While these figures will describe a specific set of configurations in this embodiment, it should be understood that this description is for illustrative purposes only. A person skilled in the relevant art will easily be able to recognize that other configurations, weapons, or arrangements can be used without departing from the concept, scope and spirit of this invention. It will be further evident that the invention's analysis processes can be incorporated in other structural forms without deviating from the scope and spirit of this invention.

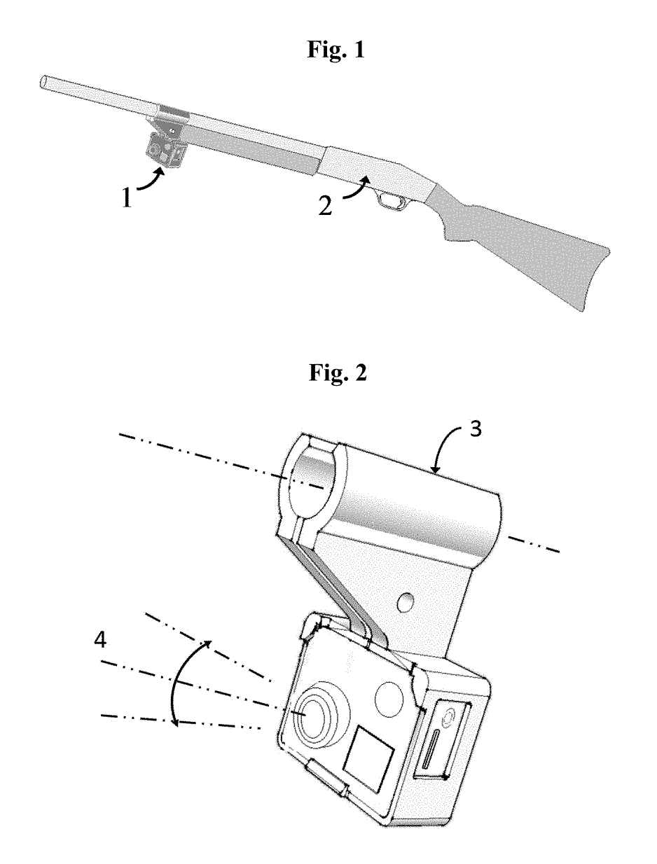

Referring now to the invention in more detail, in FIG. 1, there is shown a recording system 1 removably attached to a firearm 2. The purpose of this recording system 1 is capture in a video record the events that the firearm's operator (e.g. user) sees during the use of firearm 2 for the training experience. Be it noted that for this embodiment a shotgun is shown as the firearm 2; but other embodiments utilizing other weapons would be within the scope of this invention.

In FIG. 2, the recording system 1 is shown in more detail. The recording system 1 is mounted on the firearm 2 by a removable means. A tubular clamp mechanism 3 is shown in FIG. 2 as the means to attach, removably or permanently, to the firearm 2. The dashed line emanating from the tubular clamp 3 represents the axis of travel of the firearm's 2 projectile(s) when attached to the firearm 2 (i.e. this axis is generally coincident with firearm's 2 shot path and aiming direction when attached to the firearm 2). This mounting configuration 3 is included for the purpose of illustration, the coincident nature of the axes is a mounting convenience, not a necessity of the invention.

The viewable recording area shown by the dashed lines 4 emanating from the recording device is shown relatively coaxial with the axis of the clamp mechanism 3. An important aspect of the invention shown by these lines 4 is that the invention does not need to be coaxially aligned with the direction of the firearm's projectile. The invention is able to achieve a successful recording, and therefore result in a successful analysis, as long as the target remains in the viewing area captured by the recording device.

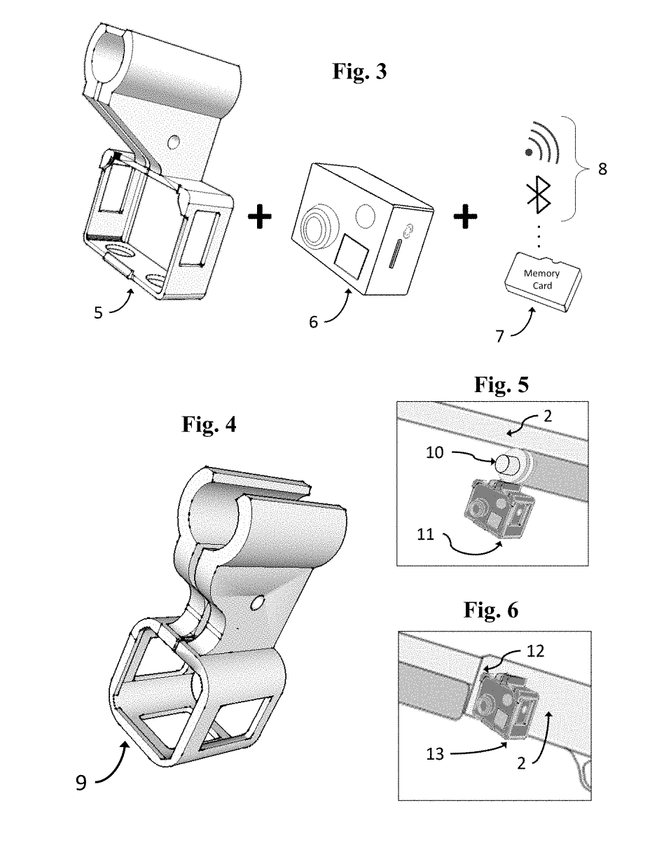

FIG. 3 shows the recording system 1 decomposed into individual components. The recording system 1 employs a fixture 5 that enables the recording system 1 to be attached to, and optionally, removed from the firearm 2, a camera 6 as the recording device, a memory card 7 to store the video record to be captured and an optional, wireless communication means 8. For illustrative purposes, the memory card shown is a microSD card 7; it is within the scope of this invention to use a substitute medium to store the recording record (e.g. SD, USB memory, flash stick, disk drive, tape). Furthermore, for the wireless communications means 8, Bluetooth and Wi-Fi are represented in FIG. 3; these are representative wireless communications shown as a specific embodiment. Other wireless communication means still fits within the scope of this invention; such wireless control may involve remotely turning on and off the camera 6, controlling video capture settings on the camera 6, and transferring captured video from the camera 6 directly to a computing device, without requiring the video file(s) to be saved on the camera 6 first. Furthermore, it is within the scope of this invention to modify the firmware on the mounted camera 6 to utilize the techniques described below for detecting shot-fired events and only recording and transferring briefs snippets of video prior to and following those events.

As a means to further illustrate that the specific configuration of the fixture 5 could be achieved by other configurations, FIG. 4 shows an alternate fixture 9 that is functionally the same as the fixture 5 shown in FIG. 3 and falls within the same scope of this invention.

FIGS. 5 and 6 show that fixture 5 can be mounted in other ways and still achieve the objectives of the invention. FIG. 5 shows another fixture configuration 11 mounted on the firearm 2 behind the magazine cap 10 of the firearm 2. FIG. 6 shows yet another fixture configuration 13 mounted on the side 12 of the firearm 2. As clarification for this invention, the invention will be able to successfully analyze the training record as long as the target remains within view of the recording record during the portion of the record that is to be analyzed.

When a training event is to be recorded for analysis by the invention, the recording system 1 is attached to the firearm 2 as shown in FIG. 1. Next, the recording system 6 is activated to record the training event. For the purposes of this embodiment, the training event assumed will be trap shooting (i.e. a trap round) with a shotgun as the firearm 2.

Since the camera 6 is firmly mounted on the shotgun 2, the shotgun's 2 aimpoint does not change with respect to coordinates on the video frame. More Specifically, a location (X aimpoint, Y aimpoint pixels on the video's frame), which is consistent with the shotgun's 2 aimpoint at a given frame in the video, will remain consistent with the shotgun's 2 aimpoint throughout the other frames in the video. This condition remains true as long as the camera 6 does not move relative to the shotgun 2.

Optionally, the invention's accuracy can be improved with a calibration process to precisely identify this aimpoint location on the video. This calibration between the shotgun 2 and the recording device 6, e.g. camera, can be conducted in many ways and still remain consistent with the scope of the invention. For the purposes of further illustration, the following details a specific calibration routine. Before the user begins the trap round, the camera 6 is activated to start recording. The user points the shotgun 2 at a placard that is used for calibrating the aimpoint.

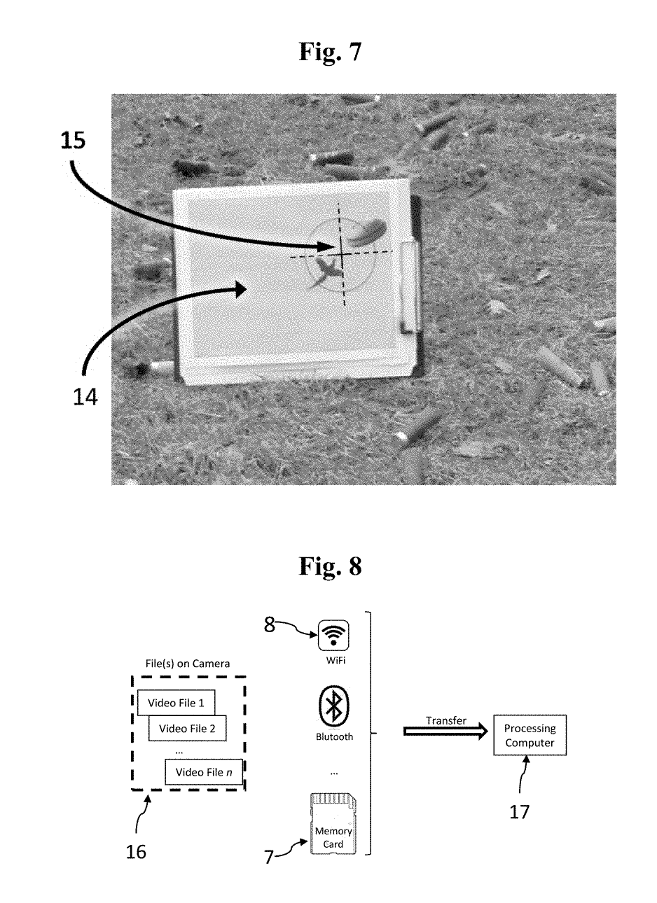

The placard used in this illustration, as shown in a black-and-white image on FIG. 7, was an 8.5″×11″ sheet of bright yellow card-stock paper. This placard 14 has and area identified to the user as the aiming point, the crosshair 15, although another specific spot on the placard could easily suffice. After aiming at this crosshair 15 and holding the shotgun 2 steady for a half-second or more, the recording phase of the calibration process is complete. Then, the user starts with the trap round. When the user finishes the trap round, the camera 6 recording is stopped. The calibration process, using this portion of the video will be completed during the analysis process, described later in this section.

The camera 6 now has video file(s) 16 stored on the memory card 7 as a video record of the trap round. Next, the video record is analyzed by means of a computing device. As FIG. 8 shows, this video file(s) 16 is transferred to a computing device 17 (e.g. smartphone, tablet, computer, server) for analysis. This transferring can be accomplished by physically moving the memory card 7 or transmitted by wireless means 8 to the computing device 17. Transferring the video file 16 to the computing device 17 by means of a wired connection (e.g. USB, HDMI) is not shown but still within the scope of the invention. Since a typical trap round is comprised of twenty-five (25) shots, the video file(s) 16 would have typically a record of twenty-five (25) shots for a given trap round. For this illustration, it is assumed that the video file 16 is a single, contiguous file of twenty-five (25) shots. The invention will work the same if the trap round was captured in multiple video files 16 or if the round contained more or less than twenty-five (25) shots.

Once transferred to the computing device 17, two operations are conducted to complete the analysis portion of the calibration process. First, the first thirty (30) seconds of the video file(s) 16 is searched for an image shape that is consistent with a known shape, e.g. the placard. To identify this shape, each frame of this thirty-second video segment is reviewed by the invention's analysis algorithm. More specifically within a given video frame, the Red-Green-Blue pixel values are transformed into the Hue-Saturation-Value (HSV) domain using well-known equations. The resulting images are thresholded for pixels having H within 20-30, S within 100-255, and V within 100-255, which is a yellow color in HSV domain. Each pixel meeting these criteria is set to a white value in this thresholded image, while the rest are left dark.

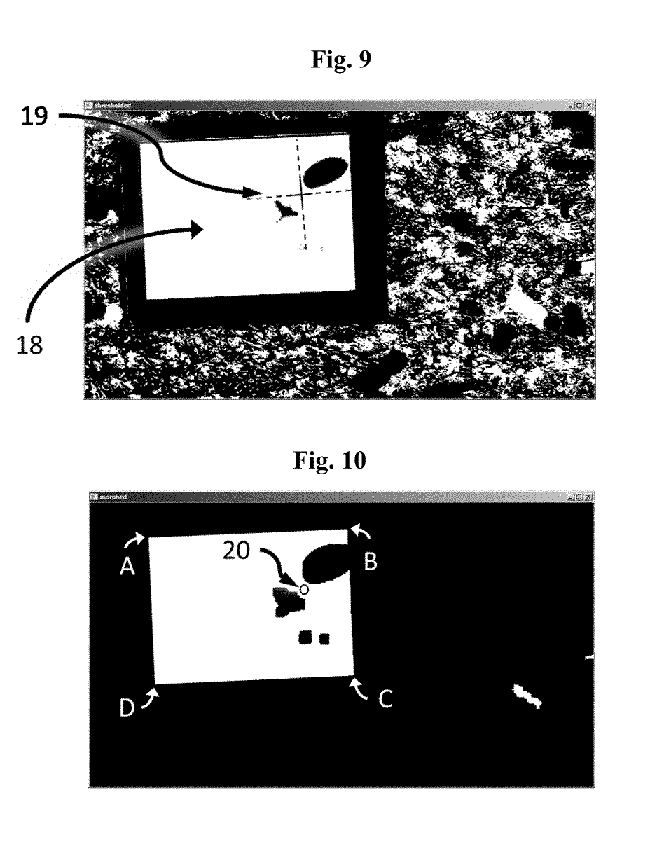

The resulting image from this thresholding process is shown in FIG. 9. The region 18 occupied by the placard is clearly seen, but yellow grass and other yellow colored objects in the video, which are also turned white by this process, produce significant visual clutter on the image. To filter this further, a morphological transform of 64×64 pixels is applied to the thresholded image, which will reduce the unintended visual clutter. The resulting output of the image is shown in FIG. 10.

Second, A contour map of this region is computed as the final part of this process. The region 18 with the largest area (i.e. the placard) is contoured by the algorithm to identify its shape. From these contours, the algorithm identifies the location of the corners of the placard, shown in FIG. 10 as points A-B-C-D. The orientation and center of this rectangular area (points A-D), or any other location on the placard, can be determined using basic geometry. With this orientation identified by points A-D the aimpoint is determined by the coordinates 20 in FIG. 10 that corresponds to the crosshair 19 location in FIG. 9.

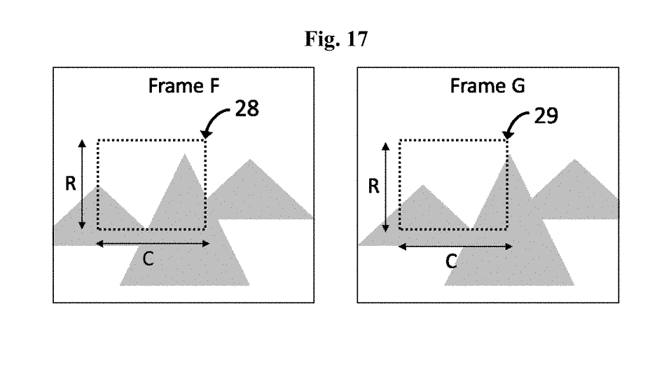

Motion between successive frames that contain a placard is computed (motion detection is described later when FIG. 17 is explained). The aimpoint is averaged only for video frames where the motion of the camera 6 is less than a specified threshold. This way, the aimpoint calculation is not affected by the placard moving rapidly as the user pans the shotgun to find the placard, or pans the shotgun away from the placard.

If no geometry is located as a result of this process, the calibration process ends and the aimpoint will be identified manually during the analysis process. This calibration, detailed in this illustration, provides a means to improve the accuracy of the aimpoint identification. The scope and performance of the invention does not require this or other calibration means.

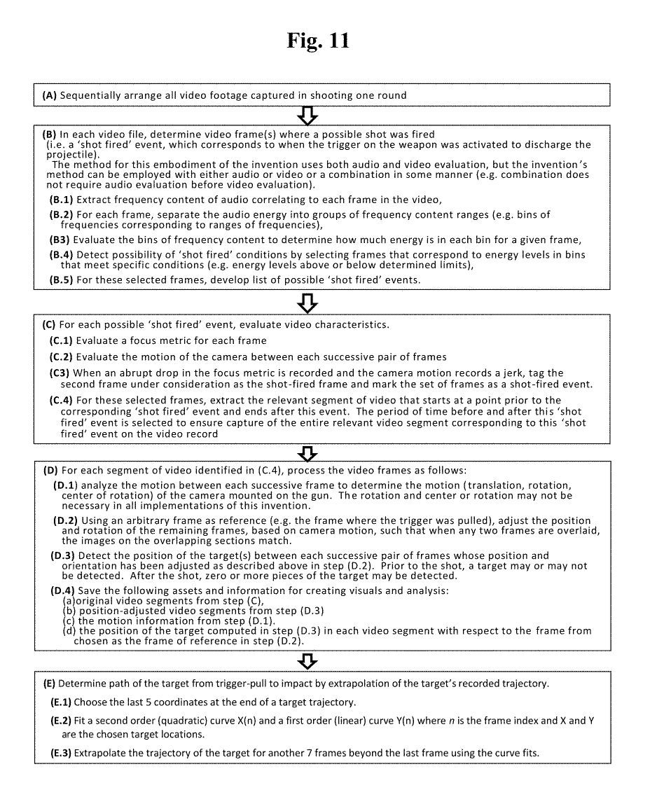

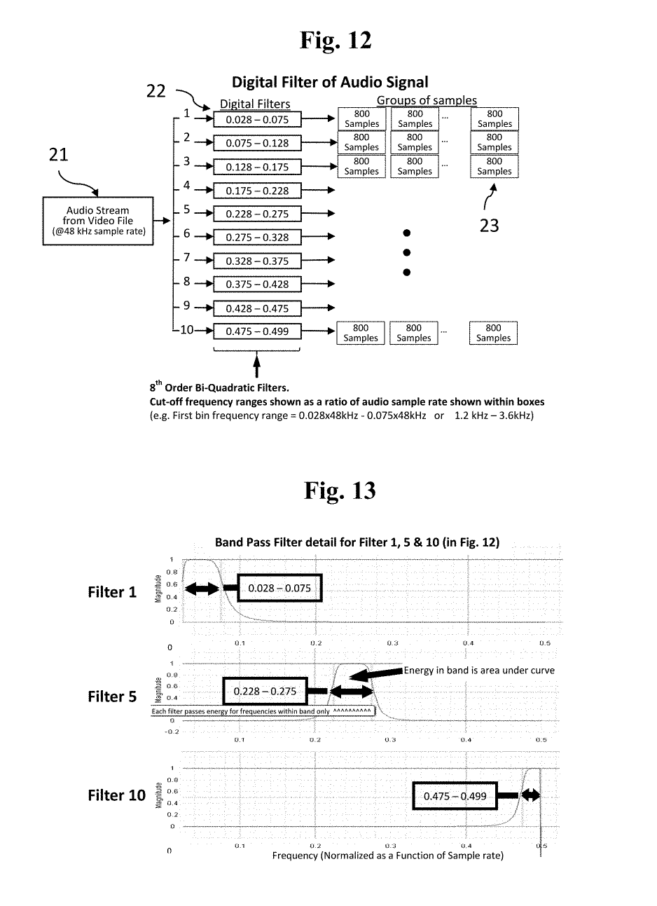

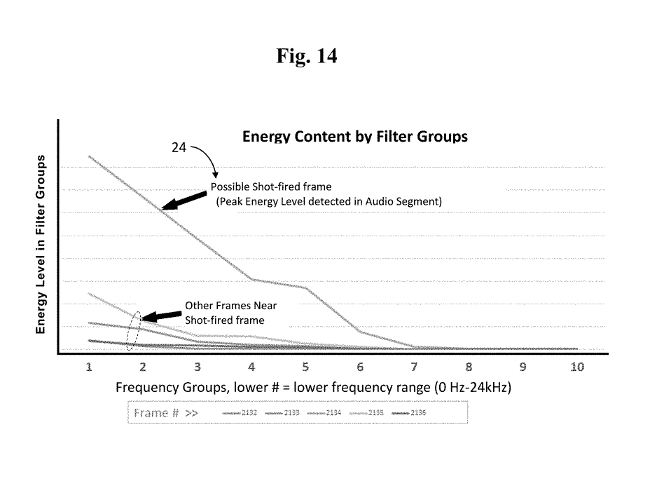

The algorithm's audio evaluation, described in section ‘B’ of FIG. 11, uses audio frequency energies extracted from each the video file(s) 16. Notably, these energies can be extracted from the video using any accepted algorithm. The following, using FIG. 12, FIG. 13 and FIG. 14, will describe this audio portion of the algorithm. The remainder of these analysis steps described in FIG. 11 will be covered, in order, later in this disclosure.

FIG. 12 shows the specific algorithm, ten bi-quadratic digital filters 22, used for the purposes of this illustration. In FIG. 12, the audio stream 21 from the video file 16 is captured at 48 kHz and passed through these bi-quadratic filters 22, with passband frequencies ranges noted for each filter node inside the bold-lined boxes. The output from each of these filters 22 is combined into groups 23 of 800 samples. These groups 23 create 60 such sets per filter output per second, which effectively approximates the video frame rate of the video file 16. Matching of this frame rate is convenient, but not necessary for this invention to work.

FIG. 13, three frequency plots show example frequency responses (pass bands) from three of these groups 23. Energy within each group 23, which is computed by computing the root-mean-square (RMS) of the group's 23 samples, is stored as one value for that group, effectively becoming one value per frame for this illustration. Therefore, an audio stream 21 comprising of 48,000 samples per second is transformed into a stream of ten energy values per frame, computed 60 times per second.

To further illustrate the output of this algorithm, the values for these ten groups 23, per frame, are graphed in FIG. 14. Of the five frames graphed in FIG. 14, one frame 24 exhibits much higher energy levels than the rest. This frame 24 coincides with a ‘shot-fired’ event, as noted on the graph.

A possible ‘shot fired’ event is determined when the level of energy in these groups 23 exceed a given limit determined by an analysis characterization. Each frame that meets the conditions set by the characterization are identified as a possible ‘shot fired’ event 24. This analysis characterization refers to a frame-by-frame review of each frame's stored energy values for a representative video file 16. The results of this review set the levels that are the conditions used to determine possible ‘shot fired’ conditions for other video files 16. As a means of illustration for this preferred embodiment, this analysis characterization for shotgun shots determined that the frequency groups between 6,000 Hz and 15,600 Hz had most of the energy recorded on the video during ‘shot-fired’ events. After reviewing a control group of shotgun shots recorded on video using this analysis characterization approach, the lowest levels measured for these frequency groups became the limits used to determine possible shot fired frames 24 for other video files.

Referencing section ‘C’ of FIG. 11, the algorithm then evaluates video characteristics of the frames identified as possible ‘shot fired’ events. This step serves two purposes. First, it rejects false shot-fired events that may have been identified by the audio analysis. Second, it locates the precise video frame where the camera 6 registers a shot-fired event, so that subsequent analysis may be synchronized across multiple shots to the frame(s).

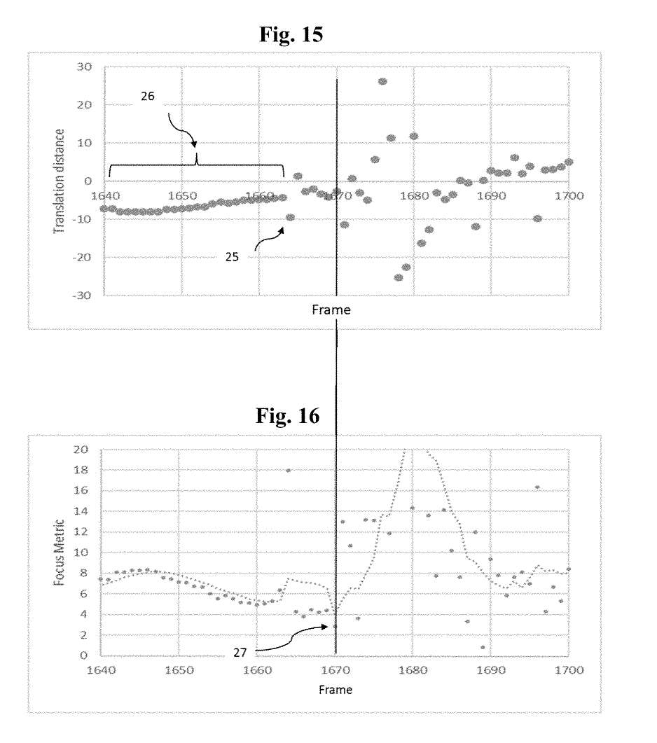

The graphs shown in FIG. 15 and FIG. 16 show two parameters, translation distance and focus metric, respectively, plotted for a segment of the video file 16. These parameters are used to confirm the ‘shot-fired’ frame(s) from the possible ‘shot-fired’ frame(s) selected in the audio analysis.

The Translation Distance, shown in FIG. 15, is determined by extracting the motion between successive frames. Specifically, this motion between these frames is calculated by subtracting the amount of translation (Δx, Δy), amount of rotation angle, and the center of rotation (Cx, Cy) of the first frame with respect to the second frame.

Referring now to FIG. 17, to compute translation distance, a small, R pixel tall and C pixel wide region 28 from Frame F and the same sized region 29 from Frame G, which is the next frame after Frame F, are extracted for analysis. The height R and width C of this region should be significantly greater than the maximum anticipated motion of the video between two successive frames. For example, to estimate no more than 15 pixels of motion along one or both axes, R=80 and c=120 generally suffices. Larger values are permissible, but increase the complexity of the motion detection calculation.

The offset position of the regions 28 and 29 within Frames F and G, respectively, must be the same. Δx and Δy are computed by minimizing Σᵣ₌₁^{R}Σ_{c=1}^{C}(F(r,c)−G(r−Δy, c−Δx))². For algorithmic efficiency, Δx and Δy can be computed by applying a Hanning window to each region and calculating the phase correlation to determine Δx, and Δy. A potential problem arises when the images in regions 28 and 29 are featureless (for example, solid color, blue skies). For this or similar cases, other regions on the video frames F and G will be used to estimate motion. To avoid these potential problem conditions, regions towards the bottom of the video frame tend to be better candidate areas, as this part of the frame typically stays below the horizon and enables greater probability of features within the measurement frame.

The focus metric, shown in FIG. 16, is calculated for each frame is calculated from a portion of the video frame—a high number represents sharp focus, while a low number represents a blurry image. Several methods exist for determining the focus metric. A specific method that can be used to calculate this metric is to compute the Laplacian value at each pixel using the pixel values of one of the three color channels (for example, the red channel). The Laplacian function

$$L ( f ) = \frac{{\partial }^{2} f}{\partial {x}^{2}} + \frac{{\partial }^{2} f}{\partial {y}^{2}}$$

may be approximated in discrete time, using x for pixel distance in columns, y for pixel distance in rows, and f as the pixel value. Averaging |L(ƒ)| over a region of video yields a focus metric for that region. This focus metric can vary significantly based on the content of a video frame; however, a large reduction, typically greater than in its value from one frame to the next can detect a sudden blurriness event, as the content of the video is substantially the same. Typical focus metric values tend to be in the 10-25 range for videos captured on sunny days, while videos shot in the snow tend to a metric of 5-15. Regardless of the weather conditions, a >30% drop in focus metric, from one video frame to another is generally indicative of a shot-fired event. When this decision threshold is combined with the audio and motion cues, shot-fired events are extracted with high accuracy, with the shot-fired frame correctly identified.

Individually, changes in the translation distance or the focus metric cannot reliably be used to detect a shot. But, when both parameters are evaluated together, a shot can be reliably determined. Therefore, this evaluation of both parameters, as a collection, becomes the detector used to detect ‘shot-fired’ conditions.

To illustrate this detector, FIGS. 15 and 16 is an example of this approach used to qualify a shot fired in the sequence of events. The vertical line, passing through sample 1670 on both figures, indicates that a shot has indeed been fired in that frame. Specifically, this detector looks for a large drop 27 in focus (e.g. the >30% drop mentioned earlier) occurring after a period of smooth motion 26. An advantage of this approach is that a jerky motion event 25 that is not accompanied by a focus metric drop does not cause a false shot-fired detection.

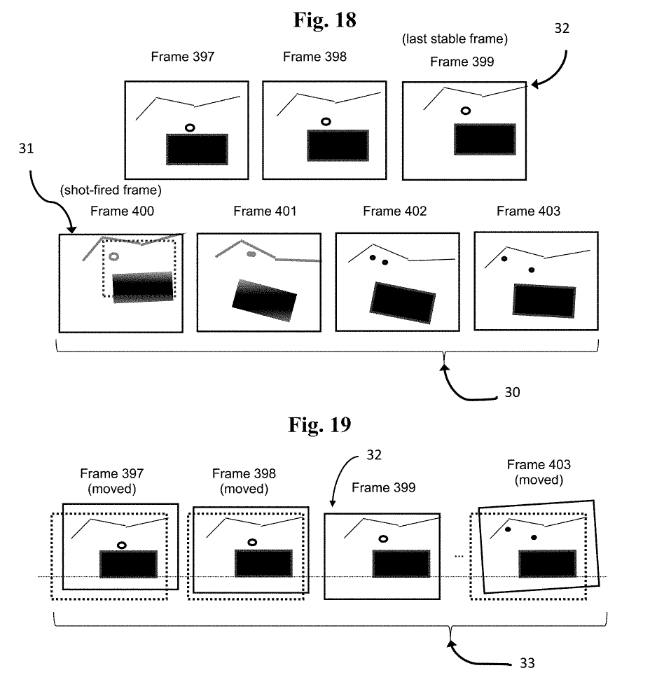

After this, the algorithm creates multiple video segments around each video frame where a shot-fired event is detected. As an example, FIG. 18 depicts the contents of a segment 30 where the shot-fired frame 31 has an index of “Frame 400.” A specific example for illustrative purposes, 1.5 seconds of video before and one second after the shot-fired frame are saved within a segment. The duration of video saved prior to and after the shot-fired frame can be varied to suit the needs of the users. The process for detection and identification of the shot-fired frame is described in more detail below.

Referencing section of FIG. 11, motion within each video segment is analyzed to estimate the motion of the camera 6 panning from the first frame in the video segment to the stable frame 32, which is just prior to the shot-fired frame 31. Since the shot-fired frame 31 captures significant motion resulting from the shot, this stable frame 32 is used as the reference frame to find the target and aimpoint motion.

Then, as shown in FIG. 19, the algorithm repositions each video frame in reference to the frame 32 to create an offset video segment 33, so that the majority of the video appears stationary; this operation has the effect of highlighting more strongly only the object(s) in the video sequence, including the target, that are moving with respect to the background scenery.

Motion estimation between successive video frames is can be efficiently accomplished in multiple ways. As part of this illustration, motion between a frame and the last-stable frame 32 is calculated by summing up the motion between each pair of successive frames between that frame and the last-stable frame 32. More specifically, motion estimation was calculated using phase correlation techniques applied to a rectangular portion of the image at the center of each video frame. The resulting data was checked for sanity—if the calculated motion estimate exceeded a specified threshold, other regions on the two frames being compared were used to estimate motion until a reasonable value was computed. This sanity check guards against erroneous motion estimation when the center of the video lacks any features that would enable the phase correlation to detect motion (e.g. blue skies or uniform snow).

Continuing further with the description in section ‘D’ of FIG. 11, FIG. 19 shows the difference between successive frames within the offset video segment 33 is used to locate the position of the target(s) at specific points within each video segment 30. One example of these points, the location of the target at shot-fired point, is particularly important as it is used to determine a hit or a miss for that shot.

For this hit/miss determination, the algorithm checks if the location of the target in the shot-fired frame 31 is within a specified region of the aimpoint of the shotgun. If this is the case, the shot is registered as a hit; otherwise, it is registered as a miss. The region can be adjusted to reflect the width of the shotgun's pellet pattern radius. This region is the effective impact zone of the shotgun's projectile(s) (e.g. pellet pattern).

To end this portion, as detailed in D.4 of FIG. 11 and illustrated in FIGS. 18 and 19, the algorithm creates a dataset comprising of one video segment 30, one offset video segment 33, the motion data between each frame, the target position data within each frame, the location of the aimpoint, and whether the shot resulted in a hit or a miss. In the typical round of trap shooting, twenty-five such sets are stored locally on a computing device 17 or remotely on another computing device (e.g. PC, computer, server). It is clearly within the scope of the invention for the digital storage to be connected through an internet (LAN, intranet or related) architecture (e.g. virtualized, managed, or ‘cloud’ storage).

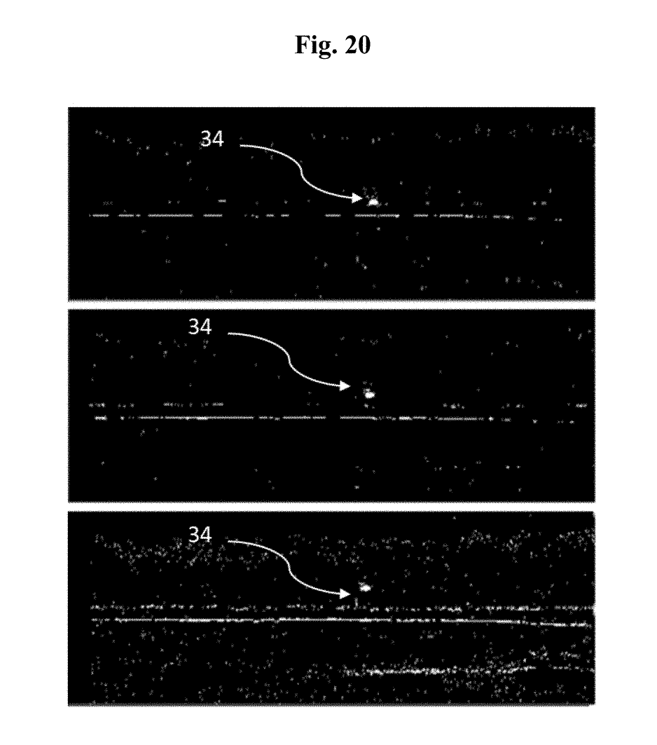

In the last phase of the algorithm, referencing section ‘E’ of FIG. 11, target tracking is determined, as illustrated with FIG. 20 through 23. To successfully track a target, this invention uses the offset video segments 33, detailed in FIG. 18 and FIG. 19, for target detection. Each offset video frame is subtracted from the video frame after it. Pixels that are darker than a certain threshold are set to black, while the rest are set to white.

FIG. 20 shows an example of three successive frames that have been thresholded in this manner. A target 34 is visible in each of the sequences, but is neither the sole bright object, the largest bright object, nor an object that has a consistent shape. This invention uses three primary detection strategies to not just locate targets, but also locate trajectories traced by the targets across multiple frames. Depending on the environmental conditions, the tree lines and the other landscape features, one strategy often works better than the other.

The first strategy is implemented as follows. To locate a target object 34 within these noisy images, this invention adjusts the threshold value, and only considers objects, shown as other white regions in FIG. 20, that falls within a certain size (as measured by the number of connected pixels after thresholding) and have a certain aspect ratio. Starting with the largest object found, it looks within each frame for confirmation that this object 34 is indeed moving in a kinematically-consistent manner. Kinematic consistency checks include for very small curvature (e.g. aircraft or false detection(s) from reflections moving along straight edges), very sharp curvature or trajectories involving multiple loops. Once a target object 34 meeting these criteria is found in multiple consecutive frames (e.g. at least 4 frames), this target 34 can be tracked using a very narrowly defined search window around its last detected location. This search window is incremented to the next frame(s) based upon a kinematic projection using target object 34 locations from these prior, consecutive frames.

A second strategy is implemented as follows. The location of the brightest point(s), e.g. possible object(s) 34, that meet a specified minimum size are aggregated from each of the thresholded frames (as described above). All of these objects 34 meeting these requirements, that also are also located within an area defined by a region (e.g. oval or other shaped mask), which is centered on a chosen point of the video frame (e.g. center of frame, aimpoint, or other specific point), are selected as possible target locations.

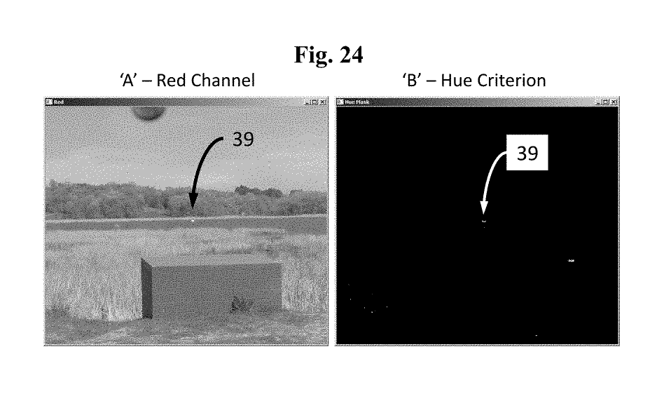

A third strategy is implemented by modifying the second strategy as follows. This strategy exploits the fact that the target usually appears red. The hue of a pixel is indicative of the dominant color of that pixel. The saturation of the pixel is indicative of how much color is in the pixel. To illustrate this point, a red pixel and a gray pixel both can both contain the same amounts of red, but the hue and saturation value of the red pixel (e.g. 10 and greater than 70 respectively) will differ significantly from the gray pixel's (e.g. any hue, but less than 10 saturation). In the third method, therefore, in addition to searching for the brightest points, a check is made on the second of the original two images that were subtracted in [0085] above. If the hue of the pixel value falls within 0-15 or within 165-180, and the saturation is greater than 70, only then is the brightest point considered as a trajectory candidate. FIG. 24 shows the difference in the video data when the red channel is used (A) versus the hue criterion is used (B). When the hue is used, the target 39 is more prominent than the target 39 in the same frame, when the red channel is used. It is clearly within the scope of this invention that other color may be used with this strategy to achieve the same outcome for targets exhibiting different hue and saturation values.

As a result of restricting the algorithm's focus to these masked region(s), this process excludes peripheral artifacts caused by reflections from unintended (e.g. non-target) objects, such as the shotgun barrel, the trap house, or other objects. Therefore, the algorithm processes the video frames much more efficiently and effectively, which results in much faster detection of possible target objects 34.

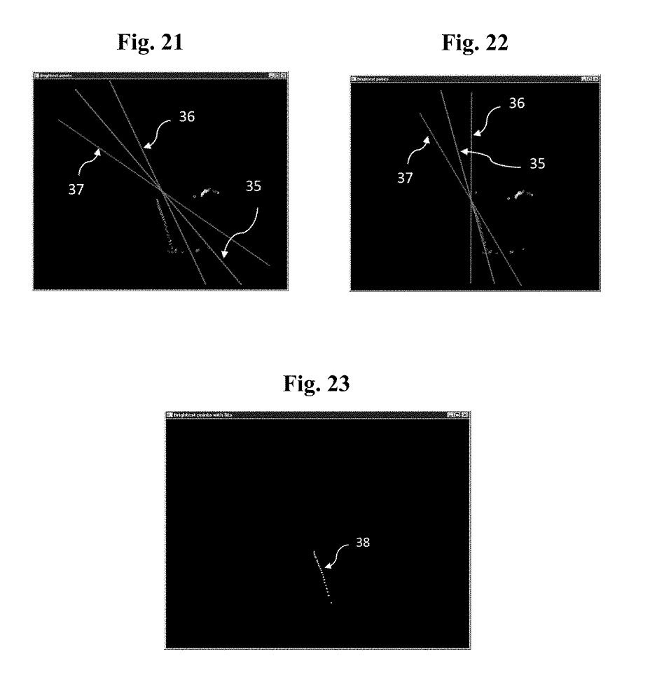

An illustration of a resulting cluster of points from this process is shown on FIGS. 21, 22 and 23. Next, all reasonable combinations of two point pairs are considered for the points in this cluster. FIGS. 21 and 22 show two examples of such combinations. A line 35 is drawn through each possible set of points. Two lines—one 36 rotated by 15 degrees and the other 37 by −15 degrees are drawn through each of the points. Points that lie within this 30-degree span, created by these lines, are curve fitted using a quadratic equation. Although a quadratic equation is described for this illustration, other fitting algorithms can be used and are still within the scope of this invention.

From this set of points, only points that yield a reasonable curve fit are considered as candidate points. The count of such points is recorded. This process is repeated for all possible point pairs. The pair that produces the highest count of fitted points (e.g. winning combination) is selected as the set of target points. The trajectory traced by these points is selected as the seed trajectory. In this example, the trajectory 38 depicted in FIG. 23 shows only the winning combination from this selection process. As with the first strategy, a more detailed target search, using the same algorithmic approach, is conducted near this seed trajectory to find missing target objects 34 along/on this trajectory.

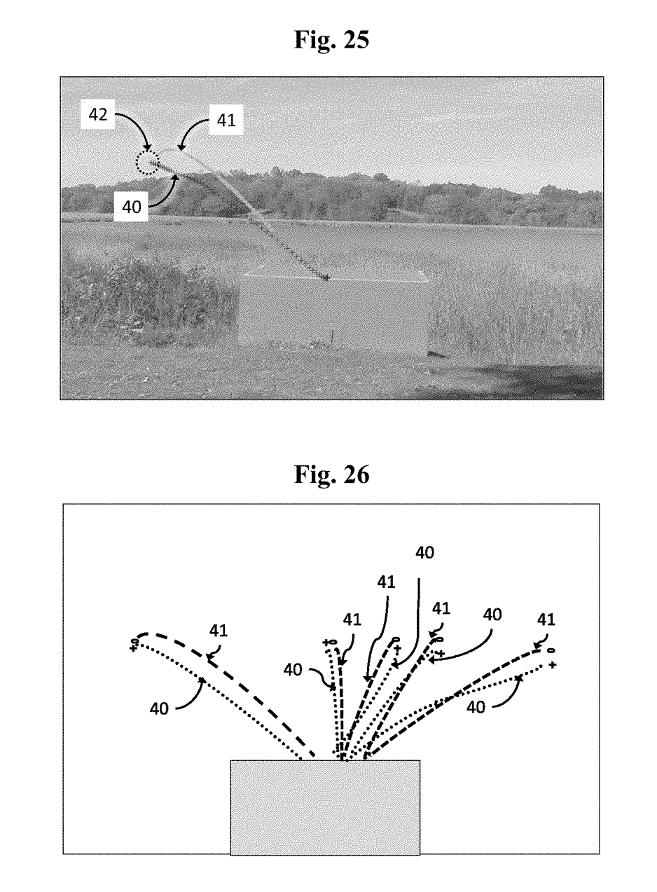

In FIG. 25, the last-stable frame 32 of the video file 16 has been annotated with the aimpoint and target(s) paths derived from the analysis outlined in FIG. 11 from the video file 16. This permits the user (or other observer) to see both the paths (e.g. the target(s) 41 and the aimpoint 40 in one view), which enable a more comprehensive and effective training experience. By seeing this entire sequence annotated in a single view, the user (or observer) is better able to visualize and understand areas to improve in the shooting experience.

Furthermore, to further develop the annotation concept outlined in FIG. 25, this annotation can be improved upon by building consecutive pairs of aimpoint and target(s) locations on corresponding frames within the video file(s) 16. Effectively, annotating one pair of coordinates from each corresponding frame. Aggregating these annotated pairs on the frame(s) effectively replicates the target(s) and aimpoint motion of the entire training record. Using all of the animated views similar to FIG. 25, the replay of the training record enables a ‘live’ replication of the actual training experience, which creates a more effective training experience for the user and observer(s). Given that the aimpoint and target(s) are referenced, it is understood that the relative location of these coordinates enables the invention to identify if the target is considered a hit or amiss. Specifically, in the illustrated embodiment with the shotgun as the firearm 2 of choice, the aimpoint has a region 42 around it that corresponds to the shot pattern. As highlighted earlier, a target that is within this region 42 it would be considered a hit by the invention.

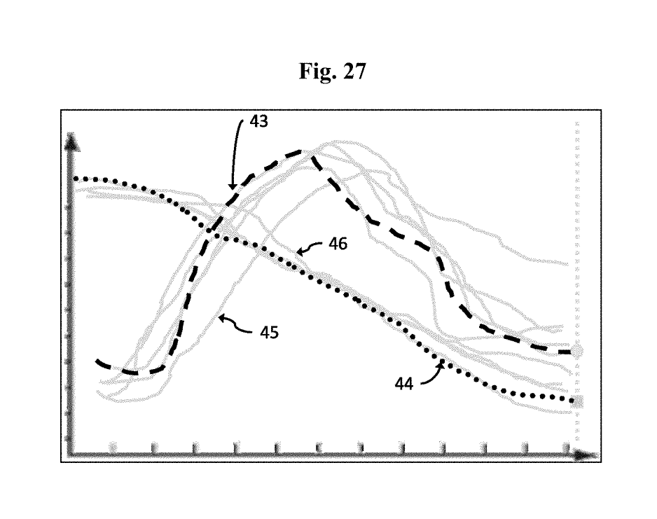

To enhance the training experience further, this invention enables the aggregated data from the training experiences, either specific shot occurrences, parts of or entire training records to be combined into one (or a set of) view(s). FIG. 26 and FIG. 27 are examples of these combined views. In FIG. 26, the aimpoint and target(s) paths (40 and 41, respectively) are combined from multiple training experiences. Specifically, it is easy to see that the left-most aimpoint and target(s) pair (40 and 41) in FIG. 26 is consistent with the aimpoint and target(s) pair (40 and 41) from FIG. 25. Furthermore, as illustrated in FIG. 26, the aggregation of multiple coordinate pairs (40 and 41) develops a view that can show the user or observer patterns in the training record that would not be apparent from replaying an ordinary recording of the training experience.

FIG. 27 shows a graph of the difference of the target(s) and aimpoint positions between consecutive frames, which create a representation of the aimpoint velocity 43 and target(s) velocity 44 for the aimpoint and target(s), respectively, throughout the shot event(s). These velocities, generated by the invention's process, provide additional training information for the user (or observer). This information can detect how smoothly the shotgun 2 is being swung during the shooting experience. Additionally, the synchronized velocities of both the aimpoint and target(s) can communicate how effectively the user is acquiring and tracking the target(s) during the shooting experience. Furthermore, when multiple velocity graphs are aggregated for the aimpoint and target(s) (the multiple, solid lines 45 and 46, respectively), there is yet additional information that can be derived. Specifically, this aggregated information can detect how consistently the user has tracked the target(s) with the shotgun 2 during the training experience. This tracking performance is measured by how tight the grouping 45 is of the aggregated aimpoint velocity graphs.

The advantage of the present invention, without limitation, is that these combined views, relevant video selection, determination of target(s) and aimpoint tracking, derivation of relative velocities of said target(s) and aimpoint(s), coupled with video record 16 of the actual training experience, deliver far greater value to user or observer because they illustrate shooting experiences (e.g. habits) that are either desired or not desired much more efficiently and effectively than prior methods or systems. Furthermore, since the annotated experience illustrated in FIG. 26 and FIG. 27, is based on the user's actual shooting record, the user or observer is then able to more clearly understand how this experience can be corrected, enhanced, or improved. And further still, the present invention's analysis provides access to information about the training experience that, heretofore, was not possible in a training experience.

In a broad embodiment, the present invention is a system and method for target training and education that will improve user performance in shooting situations. While the foregoing detailed description of the present invention enables one of ordinary skill to make and use what is presently considered to be the best embodiment of the present invention. Those of ordinary skill will appreciate and understand that other variations, combinations and equivalents of the specific embodiment, method, system and examples could be created; but would still be within the scope of the invention. Therefore, the invention should not be limited to the embodiment described above, but by all embodiments and methods within the breadth and scope of the invention.

What is claimed:

1. A recording system comprising:
A recording device that is attached to a weapon for the purpose of creating a video record of the training experience;
A storage means to contain the video record for playback at a later time(s);
A means to transfer the stored video record to a compute device;
A support means that attaches the recording device, either removably or permanently, to the weapon;

2. A recording system according to claim 1, characterized by a support that is relatively co-linearly aligned with the aiming direction of the weapon,

3. A recording system according to claim 1, such that the target remains visible in the recording record while recording the shot event;

4. A recording system according to claim 1, characterized by a support that maintains a consistent, repeatable orientation with respect to the weapon during recording events.

5. A process comprising:
A calculating method to identify an object(s) in the video record
A calculating method to determine location of the objects on the video record;
A calculating method to determine the relative change of the same object(s) on individual frames of the video record;
A calculating method to determine aimpoint location of the weapon

6. A process according to claim 5, that detects the weapon's aimpoint location by pointing the weapon at a known object shape.

7. A process according to claim 5, that selects portions of the video record based on trigger events determined by the process.

8. A process according to claim 7, that uses audio analysis of the video to determine trigger events in the video record.

9. A process according to claim 8, that combines multiple trigger events to determine trigger events to improve the accuracy of the event selection in the video record.

10. A process according to claim 5, that uses video analysis techniques of the video record to determine trigger events in the video record.

11. A process according to claim 10, that uses a focus metric of the video to determine trigger events in the video record.

12. A process according to claim 5, that uses pixel-level subtraction of successive frames to determine location of objects in the video

13. A process according to claim 5, that uses successive sets of object locations to develop the path of the object(s), aimpoint, or other objects in the video

14. A process according to claim 5, that uses difference between objects in multiple frames along with the time between frames to determine a velocity profile for object(s), such as aimpoint(s) and target(s).

15. A process according to claim 5, that uses a mathematical profile, e.g. a kinematic equation or other profile, to select or reject possible object location in a video frame.

16. A process to review video and analysis for the purpose of training and education comprising:
A method to superimpose path of object(s) on the video record;
A method to determine relative location of the objects on the video record;
A method to determine the relative change of the same object(s) on individual frames of the video record;
A method to display multiple analytical information of object data, such as velocity profile, target paths, or similar, simultaneously on recorded playback, either video or annotations of simulated video.

17. A process according to claim 16, that compares target location to aimpoint location at a defined point, e.g. at impact point, to determine outcome of shot event, such as a hit or miss.

18. A process according to claim 16, that combines multiple target and aimpoint paths to show a single view of multiple shot events.
